(19) United States
(12) Patent Application Publication
(10) Pub. No.: US 2025/0355108 A1
(43) Pub. Date: Nov. 20, 2025

(54) RAVELING SPEED ESTIMATION DEVICE

(71) Applicant: DENSO CORPORATION, Kariya-city (JP)

(72) Inventors: Teppei YOSHIDA, Kariya-city (JP); Kunihiro GOTO, Kariya-city (JP); Hiroyuki HOTTA, Kariya-city (JP)

(21) Appl. No.: 19/284,172

(22) Filed: Jul. 29, 2025

Related U.S. Application Data
(63) Continuation of application No. PCT/JP2024/001615, filed on Jan. 22, 2024.

(30) Foreign Application Priority Data
Feb. 1, 2023 (JP) 2023-014075

(51) Int. Cl. G01S 13/60; G01S 13/58; G01S 13/72

(52) U.S. Cl. CPC G01S 13/60; G01S 13/588; G01S 13/72

(57) ABSTRACT

A traveling speed estimation device includes an information acquisition unit, a selection unit, and an estimation unit. The information acquisition unit repeatedly acquires, from a radar device mounted on a moving object and transmitting and receiving radar waves, observation point information items including at least an observation point relative speed, which is a relative speed between an observation point that reflects the radar wave and the radar device, and an observation point azimuth angle, which is an azimuth angle at which the observation point exists. The selection unit selects observation point information items from which a traveling speed of the moving object can be estimated that is closest to a true value from among a plurality of observation point information items. The estimation unit estimates the true value of the traveling speed based on the observation point relative speed and the observation point azimuth angle of one or more of the observation point information items selected by the selection unit.

### CROSS-REFERENCE TO RELATED APPLICATION

This application is the U.S. bypass application of International Application No. PCT/JP2024/001615 filed on Jan. 22, 2024 which designated the U.S. and claims priority to Japanese Patent Application No. No. 2023-014075 filed on Feb. 1, 2023, the contents of both of which are incorporated herein by reference.

### TECHNICAL FIELD

The present disclosure relates to a traveling speed estimation device for estimating the traveling speed of a moving object.

### BACKGROUND

JP 2003-43139 A discloses a millimeter-wave radar device configured to calculate the speed of an own vehicle from the Doppler frequency of stationary objects.

After careful consideration by the inventor, it was found that estimating the traveling speed of a moving object equipped with a radar device using radar waves reflected from stationary objects and received by the radar device can sometimes result in a decrease in the accuracy of the traveling speed estimate.

The present disclosure improves the accuracy of estimating the traveling speed of a moving object.

### SUMMARY

One aspect of the present disclosure is a traveling speed estimation device including an information acquisition unit, a selection unit, and an estimation unit.

The information acquisition unit is configured to repeatedly acquire, from a radar device mounted on a moving object and transmitting and receiving radar waves, observation point information items including at least an observation point relative speed, which is a relative speed between an observation point that reflects the radar wave and the radar device, and an observation point azimuth angle, which is an azimuth angle at which the observation point exists.

The selection unit is configured to select observation point information items from which a traveling speed of the moving object can be estimated that is closest to a true value from among a plurality of observation point information items.

The estimation unit is configured to estimate the true value of the traveling speed based on the observation point relative speed and the observation point azimuth angle of one or more of the observation point information items selected by the selection unit.

### BRIEF DESCRIPTION OF THE DRAWINGS

The above features of the present disclosure will be made clearer by the following detailed description, given referring to the appended drawings. In the accompanying drawings:

FIG. 1 shows a block diagram of a configuration of a vehicle speed estimation system;

FIG. 2 shows a diagram indicating an installation position of a radar device and an object detection area;

FIG. 3 shows a flowchart of a vehicle speed estimation process according to a first embodiment;

FIG. 4 shows a diagram explaining how to determine whether an object is stationary;

FIG. 5 shows a flowchart of a vehicle speed estimation process according to a second embodiment;

FIG. 6 shows a flowchart of a vehicle speed estimation process according to a third embodiment;

FIG. 7 shows a diagram of a vertical azimuth angle;

FIG. 8 shows a flowchart of a vehicle speed estimation process according to a fourth embodiment;

FIG. 9 shows a diagram of a horizontal azimuth angle range;

FIG. 10 shows a flowchart of a vehicle speed estimation process according to a fifth embodiment;

FIG. 11 shows a flowchart of a vehicle speed estimation process in the sixth embodiment; and

FIG. 12 shows a flowchart of a vehicle speed estimation process according to a seventh embodiment.

### DETAILED DESCRIPTION OF THE PREFERRED EMBODIMENTS

One aspect of the present disclosure is a traveling speed estimation device including an information acquisition unit, a selection unit, and an estimation unit.

The information acquisition unit is configured to repeatedly acquire, from a radar device mounted on a moving object and transmitting and receiving radar waves, observation point information items including at least an observation point relative speed, which is a relative speed between an observation point that reflects the radar wave and the radar device, and an observation point azimuth angle, which is an azimuth angle at which the observation point exists.

The selection unit is configured to select observation point information items from which a traveling speed of the moving object can be estimated that is closest to a true value from among a plurality of observation point information items.

The estimation unit is configured to estimate the true value of the traveling speed based on the observation point relative speed and the observation point azimuth angle of one or more of the observation point information items selected by the selection unit.

The traveling speed estimation device disclosed herein, which is configured in this manner, can reduce the contribution of the observation point information items that results in the traveling speeds estimation that deviate from the true value, thereby improving the accuracy of the vehicle speed estimation for the moving object.

### First Embodiment

The first embodiment of the present disclosure will be described below with reference to the accompanying drawings.

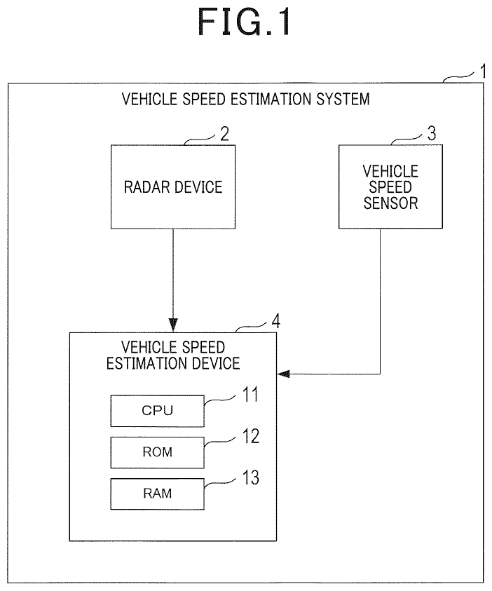

A vehicle speed estimation system 1 in the present embodiment is installed in a vehicle and, as shown in FIG. 1, includes a radar device 2, a vehicle speed sensor 3, and a vehicle speed estimation device 4.

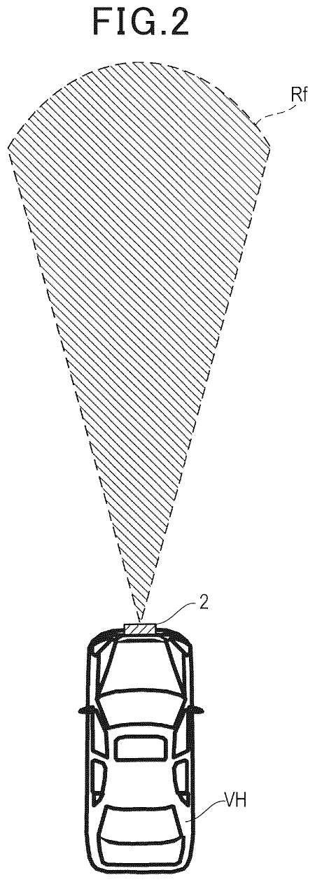

The radar device 2 is installed at the front of a vehicle VH equipped with vehicle speed estimation system 1, as shown in FIG. 2. The radar device 2 transmits radar waves toward the front of the vehicle VH and detects objects existing within an object detection area Rf in front of the vehicle VH by receiving the reflected radar waves.

The radar device 2 employs, for example, the well-known FMCW method, and transmits radar waves in the upward modulation section and downward modulation section alternately at a predetermined modulation cycle, and receives the reflected radar waves. FMCW stands for Frequency Modulated Continuous Wave. As a result, the radar device 2 detects a distance R to a point where the radar wave is reflected (hereinafter referred to as an observation point), a relative speed Vr of the observation point, a horizontal azimuth angle θ of the observation point, and a vertical azimuth angle φ of the observation point for each modulation cycle. The horizontal azimuth angle θ is an azimuth along the width of the vehicle VH. The vertical azimuth angle ϕ is an azimuth along the height direction of the vehicle VH. In addition, the radar device 2 outputs observation point information items indicating the detected distance R, the relative speed Vr, the horizontal azimuth angle θ, and the vertical azimuth angle φ to the vehicle speed estimation device 4.

The vehicle speed sensor 3 outputs a pulse signal, in which an edge occurs at a predetermined angle in response to a rotation of a drive shaft of the vehicle VH, as a vehicle speed detection signal to the vehicle speed estimation device 4. The vehicle speed estimation device 4 calculates a traveling speed of the vehicle VH (hereinafter referred to as a vehicle speed) based on the vehicle speed detection signal obtained from the vehicle speed sensor 3.

As shown in FIG. 1, the vehicle speed estimation device 4 is an electronic control device mainly composed of a microcomputer equipped with a CPU 11, a ROM 12, a RAM 13, etc. The various functions of the microcomputer are realized by the CPU 11 executing programs stored in a non-transitory tangible storage medium. In the present example, the ROM 12 corresponds to a non-transitory tangible storage medium that stores the program. In addition, executing this program will execute the method corresponding to the program. Note that some or all of the functions performed by the CPU 11 may be configured in hardware by one or more ICs, etc. In addition, the number of microcomputers constituting the vehicle speed estimation device 4 may be one or more.

The procedure of a vehicle speed estimation process executed by the vehicle speed estimation device 4 will be described. The vehicle speed estimation process is a process that is repeatedly executed while the vehicle speed estimation device 4 is in operation.

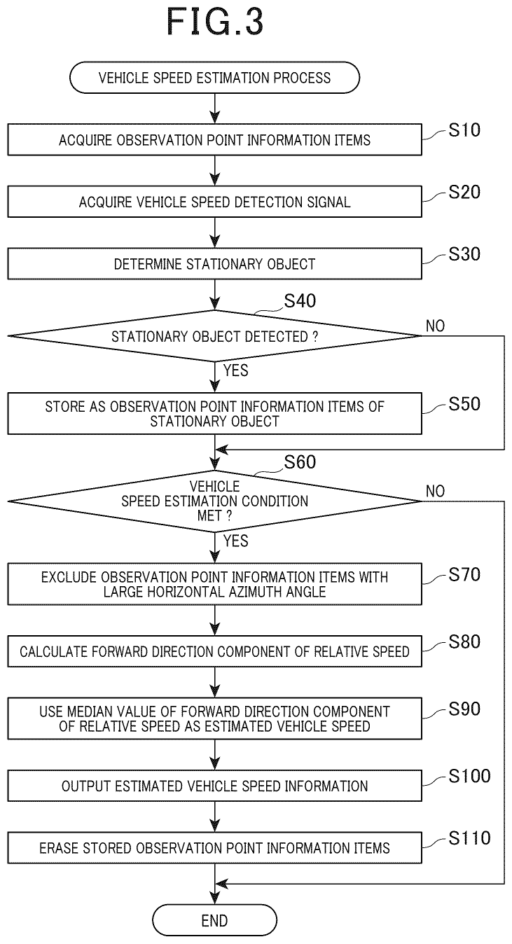

When the vehicle speed estimation process is executed, the CPU 11 of the vehicle speed estimation device 4 acquires observation point information items from the radar device 2 at S10, as shown in FIG. 3.

The CPU 11 acquires a vehicle speed detection signal from the vehicle speed sensor 3 at S20.

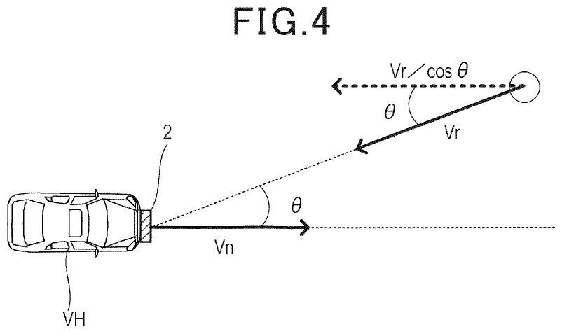

The CPU 11 determines whether the observation point corresponding to the observation point information items obtained in S10 is a point where the observation point is reflected by a stationary object (e.g., guardrail, side wall) at S30. Specifically, as shown in FIG. 4, the CPU 11 determines that the observation point is a point reflected by a stationary object when the absolute value of (Vn−Vr/cos θ) is near zero. Note that Vn is the vehicle speed calculated based on the vehicle speed detection signal obtained by S20. Vr is the observation point relative speed detected by the radar device 2. θ is the horizontal azimuth angle of the observation point detected by the radar device 2.

As shown in FIG. 3, the CPU 11 determines at S40 whether the radar device 2 has detected a stationary object based on the result of the determination at S30. Here, if no stationary object is detected, the CPU 11 advances the process to S60. On the other hand, when a stationary object is detected, the CPU 11 stores the observation point information items acquired in S10 as observation point information items of a stationary object (hereinafter referred to as a stationary observation point information items) in the RAM 13 in S50 and advances the process to S60.

When advanced to S60, the CPU 11 determines whether the preset vehicle speed estimation condition is met. In the present embodiment, the vehicle speed estimation condition is, for example, the passage of a predetermined execution cycle.

Here, if the vehicle speed estimation condition is not met, the CPU 11 terminates the vehicle speed estimation process. On the other hand, when the vehicle speed estimation condition is met, the CPU 11 excludes the stationary observation point information items with a large horizontal azimuth angle θ from the stationary observation point information items stored in the RAM 13 at S70. Specifically, the CPU 11 determines whether the absolute value of the horizontal azimuth angle θ included in each of the stationary observation point information items stored in the RAM 13 is equal to or greater than a predetermined first exclusion threshold, and excludes the corresponding stationary observation point information items when the absolute value of the horizontal azimuth angle θ is equal to or greater than the first exclusion threshold.

The CPU 11 calculates a forward direction component Vt of the relative speed Vr included in the stationary observation point information items for each of stationary observation point information item stored in the RAM 13 at S80 and not excluded by the process of S70. Specifically, the CPU 11 calculates the forward direction component Vt of the relative speed Vr using Vt=Vr/cos θ.

The CPU 11 calculates the median value of one or more forward direction components Vt calculated at S80 in S90, and uses the calculated median value as the estimated vehicle speed. Note that the CPU 11 may calculate the average value of one or more forward direction components Vt calculated at S80 and use it as the estimated vehicle speed, or calculate the most frequent value of one or more forward direction components Vt calculated at S80 and use it as the estimated vehicle speed.

The CPU 11 outputs the estimated vehicle speed information indicating the estimated vehicle speed calculated at S90 at S100 to an in-vehicle device that uses the estimated vehicle speed.

The CPU 11 erases the stationary observation point information items stored in the RAM 13 at S110 and terminates the vehicle speed estimation process.

The vehicle speed estimation device 4 configured in this manner is configured to repeatedly acquire observation point information items, including at least the relative speed Vr between the observation point that reflects the radar wave and the radar device 2, and the horizontal azimuth angle θ, from the radar device 2 that is mounted on the vehicle VH and transmits and receives radar waves.

The vehicle speed estimation device 4 is configured to select observation point information items from among a plurality of observation point information items that can estimate the vehicle speed of the vehicle VH close to the true value.

The vehicle speed estimation device 4 is configured to estimate the true value of the vehicle speed based on the relative speed Vr and the horizontal azimuth angle θ of the selected one or more observation point information items.

Such a vehicle speed estimation device 4 can reduce the contribution of the observation point information items that results in the vehicle speed estimation that deviate from the true value, thereby improving the accuracy of the vehicle speed estimation for the vehicle VH.

In addition, the vehicle speed estimation device 4 is configured to determine whether the observation point is a stationary observation point, which is a point where the radar wave is reflected by a stationary object. Then, the vehicle speed estimation device 4 selects the observation point information items capable of estimating the vehicle speed of the vehicle VH close to the true value from the observation point information items determined to be the stationary observation points (i.e., the stationary observation point information items). Such a vehicle speed estimation device 4 can further improve the accuracy of the vehicle speed estimation for the vehicle VH by estimating the speed of the vehicle VH based on the observation point information items of the stationary object.

Specifically, the vehicle speed estimation device 4 selects the stationary observation point information items by excluding the stationary observation point information items that causes a large error in estimating the true value (hereinafter referred to as error factors).

In addition, the vehicle speed estimation device 4 excludes the stationary observation point information items that causes error factors (hereinafter referred to as angle error factors) due to the azimuth angle at which the observation point exists (hereinafter referred to as the observation point azimuth angle). Specifically, by excluding the stationary observation point information items including the horizontal azimuth angle θ that satisfies a predetermined horizontal azimuth exclusion condition indicating that the horizontal azimuth angle θ is large, the stationary observation point information items that causes angle error factors is excluded. In the present embodiment, the horizontal azimuth exclusion condition is that the absolute value of the horizontal azimuth angle θ included in the stationary observation point information items is greater than or equal to a first exclusion threshold set in advance.

In addition, the vehicle speed estimation device 4 estimates the true value of the vehicle speed of the vehicle VH by calculating the median value of the vehicle speeds of the vehicle VH calculated based on each of the selected one or more stationary observation point information items. This allows the vehicle speed estimation device 4 to estimate the true value using a simple method of calculating the median value.

In the embodiment described above, the vehicle speed estimation device 4 corresponds to a traveling speed estimation device, the vehicle VH corresponds to a moving object, the relative speed Vr corresponds to an observation point relative speed, and the horizontal azimuth angle θ corresponds to the observation point azimuth angle.

In addition, S10 corresponds to a process as an information acquisition unit, S70 corresponds to a process as a selection unit, S80 and S90 correspond to a process as an estimation unit, and S30 corresponds to a process as a stationary object determination unit.

### Second Embodiment

The second embodiment of the present disclosure will be described below with reference to the accompanying drawings. Note that in the second embodiment, points that differ from the first embodiment will be explained. The same reference signs are used for common components.

A vehicle speed estimation system 1 of the second embodiment differs from the first embodiment in that the vehicle speed estimation process is changed.

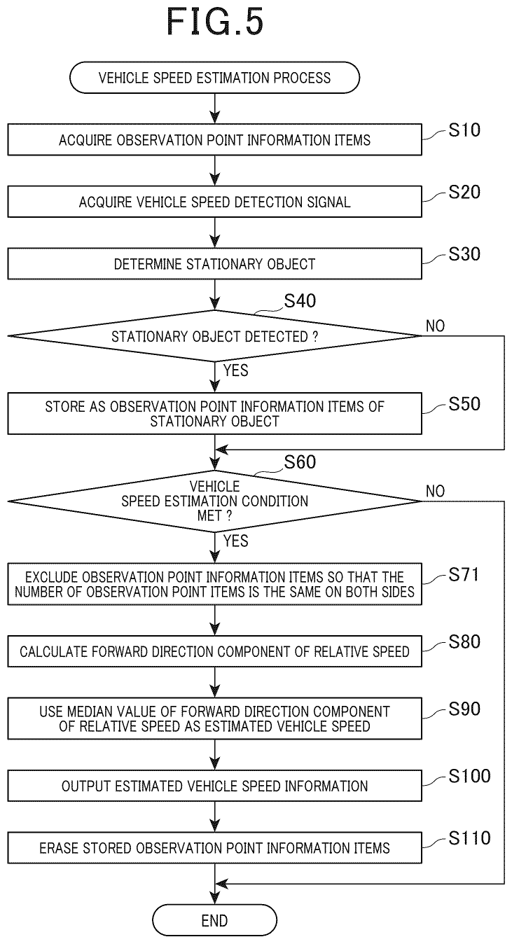

The vehicle speed estimation process of the second embodiment differs from that of the first embodiment in that the process of S71 is executed instead of the process of S70, as shown in FIG. 5.

That is, when the vehicle speed estimation condition is satisfied in S60, the CPU 11 excludes the stationary observation point information items so that the number of stationary observation points is the same on both sides in S71, and then advances the process to S80. Specifically, the CPU 11 determines whether each piece of the stationary observation point information items stored in the RAM 13 is a stationary observation point information item for a stationary object located on the left side of the vehicle VH or a stationary observation point information item for a stationary object located on the right side of the vehicle VH, based on the horizontal azimuth angle θ included in the stationary observation point information items.

Next, the CPU 11 calculates the number of the stationary observation points for the stationary objects located on the left side of the vehicle VH (hereinafter referred to as the number of left-side observation points) and the number of the stationary observation points for the stationary objects located on the right side of the vehicle VH (hereinafter referred to as the number of right-side observation points).

The CPU 11 then excludes the stationary observation point information items so that the number of the observation points on the left side matches the number of the observation points on the right side. For example, when the number of the observation points on the left side is 20 and the number of the observation points on the right side is 15, the CPU 11 excludes five stationary observation point information items for stationary objects located on the left side of the vehicle VH. Note that, the CPU 11 may exclude the necessary number of the stationary observation point information items randomly, or may exclude them in order of slow relative speed Vr, or may exclude them in order of fast relative speed Vr. Further, the CPU 11 may exclude them in order of fastest to slowest Vr/cos θ (i.e., the forward direction component Vt of the relative speed Vr).

The vehicle speed estimation device 4 configured in this manner excludes the stationary observation point information items that cause angular error by excluding the stationary observation point information items so that the number of the stationary observation point information items located on the left side of the vehicle VH (i.e., the number of left-side observation points) matches the number of the stationary observation point information items located on the right side of the vehicle VH (i.e., the number of right-side observation points). This enables the vehicle speed estimation device 4 to reduce the contribution of the observation point information items that deviate from the true value, thereby improving the accuracy of the vehicle speed estimation for the vehicle VH.

In the embodiment described above, S71 corresponds to the process as a selection unit.

### Third Embodiment

The third embodiment of the present disclosure will be described below with reference to the accompanying drawings. Note that in the third embodiment, points that differ from the first embodiment will be explained. The same reference signs are used for common components. A vehicle speed estimation system 1 of the third embodiment differs from the first embodiment in that the vehicle speed estimation process has been changed.

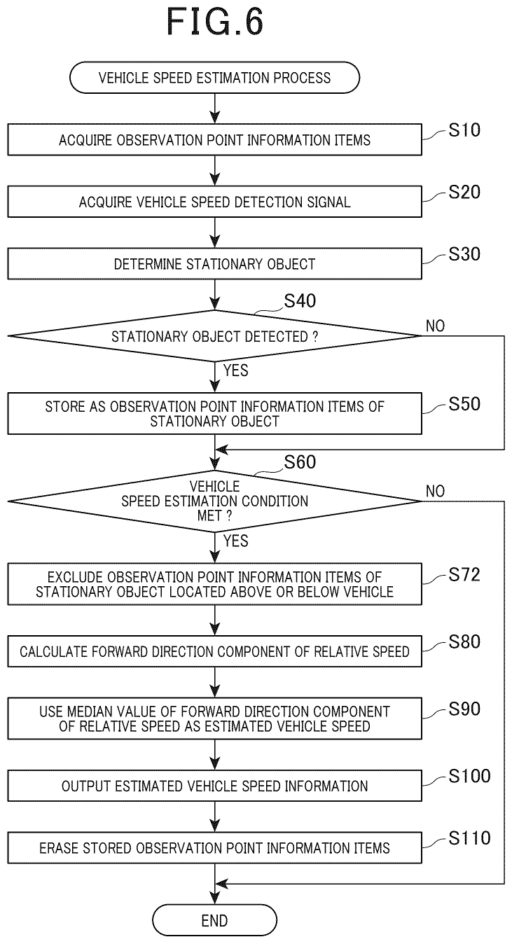

The vehicle speed estimation process of the third embodiment differs from that of the first embodiment in that the process of S72 is executed instead of the process of S70, as shown in FIG. 6.

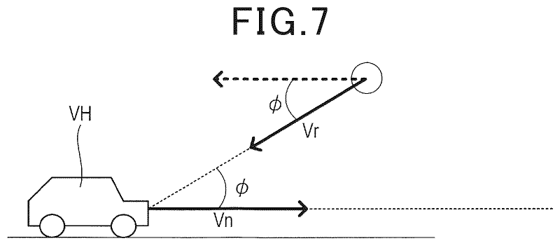

That is, when the vehicle speed estimation condition is satisfied in S60, the CPU 11 excludes the stationary observation point information items of stationary objects located above or below the vehicle VH in S72 and advances the process to S80. Specifically, as shown in FIG. 7, the CPU 11 determines whether the absolute value of the vertical azimuth angle φ included in the stationary observation point information items stored in the RAM 13 is greater than or equal to a second exclusion threshold set in advance, and if the absolute value of the vertical azimuth angle q is greater than or equal to the second exclusion threshold, the corresponding stationary observation point information item is excluded.

The vehicle speed estimation device 4 configured in this manner excludes the stationary observation point information items from the stationary observation points located above or below the vehicle VH. Specifically, the vehicle speed estimation device 4 excludes the stationary observation point information items that include the vertical azimuth angle q that satisfies a predetermined vertical azimuth angle exclusion condition indicating that the vertical azimuth angle q is large. In the present embodiment, the vertical azimuth angle exclusion condition is that the absolute value of the vertical azimuth angle φ is greater than or equal to the second exclusion threshold that is set in advance.

This enables the vehicle speed estimation device 4 to reduce the contribution of the observation point information items that deviate from the true value, thereby improving the accuracy of the vehicle speed estimation for the vehicle VH.

In the embodiment described above, S72 corresponds to the process as a selection unit.

### Fourth Embodiment

The fourth embodiment of the present disclosure will be described below with reference to the accompanying drawings. Note that in the fourth embodiment, points that differ from the first embodiment will be explained. The same reference signs are used for common components. A vehicle speed estimation system 1 of the fourth embodiment differs from the first embodiment in that the vehicle speed estimation process has been changed.

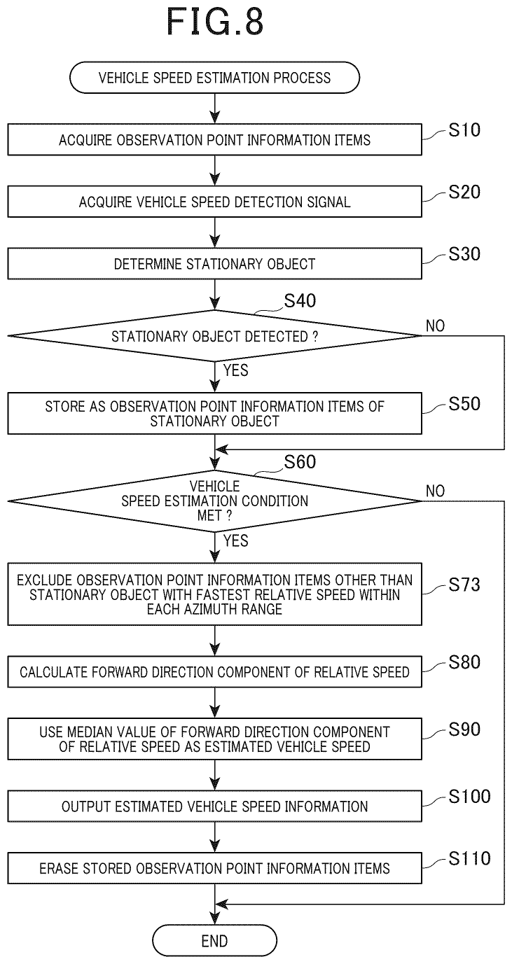

The vehicle speed estimation process of the fourth embodiment differs from that of the first embodiment in that the process of S73 is executed instead of the process of S70, as shown in FIG. 8.

That is, when the vehicle speed estimation condition is satisfied in S60, the CPU 11 excludes the stationary observation point information items other than stationary objects with the fastest relative speed within each azimuth range in S73 and advances the process to S80.

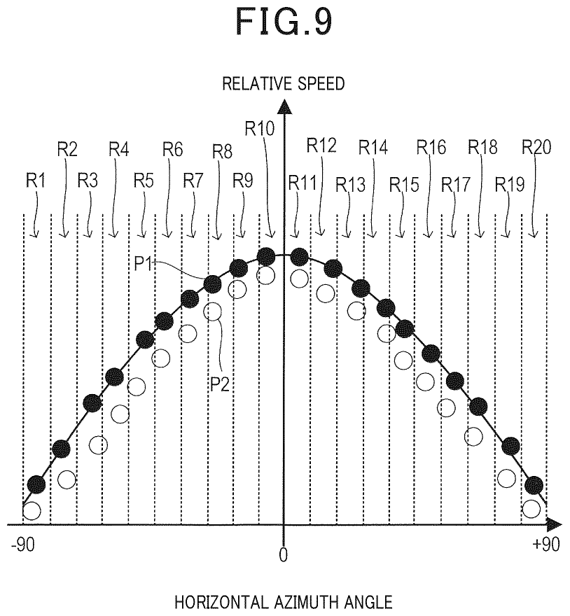

Specifically, as shown in FIG. 9, the CPU 11 determines which of a plurality of horizontal azimuth angle ranges R1, R2, . . . , R19, R20 each of the stationary observation point information stored item in the RAM 13 belongs to, based on the horizontal azimuth angle θ included in the stationary observation point information items.

The plurality of horizontal azimuth angle ranges R1, R2, . . . , R19, R20 are formed by dividing the horizontal azimuth angle θ range from −90° to +90° into 20 equal parts.

For example, a horizontal azimuth angle range R1 is −90° to −81°. A horizontal azimuth angle range R2 is −81° to −72°. A horizontal azimuth angle range R10 is −9° to 0°. A horizontal azimuth angle range R11 is 0° to +9°. A horizontal azimuth angle range R20 is +81° to +90°.

The CPU 11 extracts the stationary observation point information items with the largest relative speed Vr from among the stationary observation point information items belonging to each of the plurality of horizontal azimuth angle ranges R1 to R20, and excludes the stationary observation point information items other than the extracted stationary observation point information items. In FIG. 9, black circles indicate the stationary observation point information items with the largest relative speed Vr within each horizontal azimuth angle range. White circles indicate the stationary observation point information items that was excluded because the relative speed Vr was not the largest within each horizontal azimuth angle range. For example, a point P1 within the horizontal azimuth angle range R8 is the stationary observation point information items with the largest relative speed Vr within the horizontal azimuth angle range R8, and a point P2 within the horizontal azimuth angle range R8 is the stationary observation point information item that has been excluded because it does not have the largest relative speed Vr.

The vehicle speed estimation device 4 configured in this manner classifies each of the plurality of stationary observation point information items into one of the multiple horizontal azimuth angle ranges R1 to R20 based on the horizontal azimuth angle θ included in the stationary observation point information items. Then, the vehicle speed estimation device 4 excludes the stationary observation point information items located above or below the vehicle VH by excluding the stationary observation point information items other than the stationary observation point information items with the largest relative speed Vr from among one or the plurality of stationary observation point information items belonging to each of the plurality of horizontal azimuth angle ranges R1 to R20.

This enables the vehicle speed estimation device 4 to reduce the contribution of the observation point information items that deviate from the true value, thereby improving the accuracy of the vehicle speed estimation for the vehicle VH.

In the embodiment described above, S73 corresponds to the process as a selection unit.

### Fifth Embodiment

The fifth embodiment of the present disclosure will be described below with reference to the accompanying drawings. Note that in the fifth embodiment, points that differ from the first embodiment will be explained. The same reference signs are used for common components.

A vehicle speed estimation system 1 of the fifth embodiment differs from the first embodiment in that the vehicle speed estimation process has been changed.

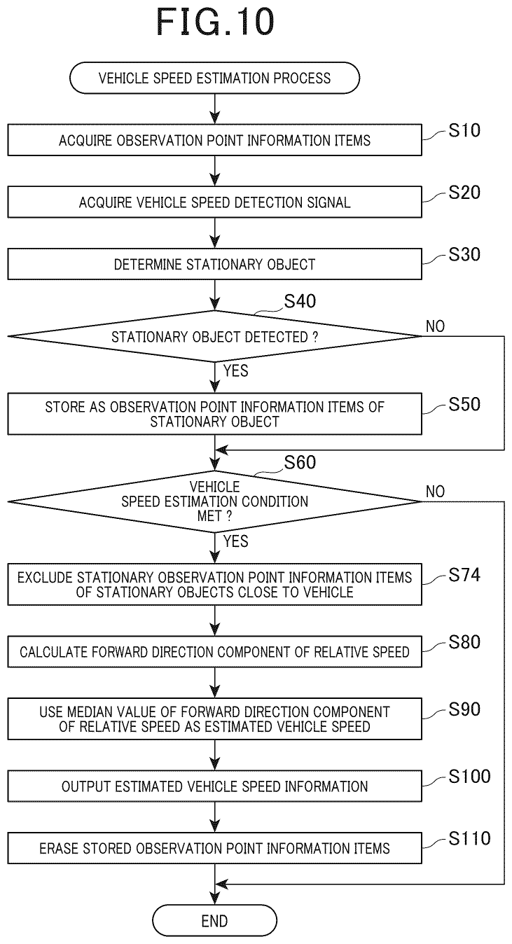

The vehicle speed estimation process of the fifth embodiment differs from the first embodiment in that the process of S74 is executed instead of the process of S70, as shown in FIG. 10.

That is, when the vehicle speed estimation condition is satisfied in S60, the CPU 11 excludes the stationary observation point information items of stationary objects close to the vehicle VH in S74 and advances the process to S80. Specifically, the CPU 11 determines whether each of the stationary observation point information item stored in the RAM 13 includes a distance R that is below a predetermined fourth exclusion threshold, and if the distance R is below the fourth exclusion threshold, the CPU 11 excludes the corresponding stationary observation point information items.

The vehicle speed estimation device 4 configured in this manner excludes the stationary observation point information items located above or below the vehicle VH by excluding the stationary observation point information items that include aa distance R that satisfies a preset distance exclusion condition indicating that the distance R is short.

This enables the vehicle speed estimation device 4 to reduce the contribution of the observation point information items that deviate from the true value, thereby improving the accuracy of the vehicle speed estimation for the vehicle VH.

In the embodiment described above, S74 corresponds to the process as a selection unit, and the distance R corresponds to an observation point distance.

### Sixth Embodiment

The sixth embodiment of the present disclosure will be described below with reference to the accompanying drawings. Note that in the sixth embodiment, points that differ from the first embodiment will be explained. The same reference signs are used for common components.

A vehicle speed estimation system 1 of the sixth embodiment differs from the first embodiment in that the vehicle speed estimation process has been changed.

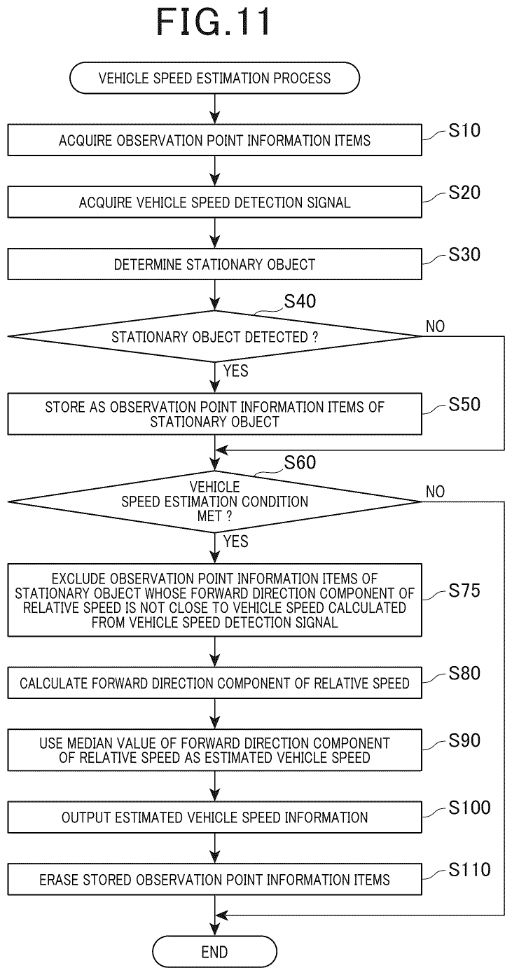

The vehicle speed estimation process of the sixth embodiment differs from the first embodiment in that the process of S75 is executed instead of the process of S70, as shown in FIG. 11.

That is, when the vehicle speed estimation condition is satisfied in S60, the CPU 11 excludes in S75 the stationary observation point information items of stationary objects whose forward direction component Vt of the relative speed Vr is not close to the vehicle speed Vn calculated from the vehicle speed detection signal, and then advances the process to S80. Specifically, the CPU 11 determines whether the forward direction component Vt of the relative speed Vr included in each of the stationary observation point information items stored in the RAM 13 is outside a predetermined exclusion range, and excludes the corresponding stationary observation point information items when the forward direction component Vt is outside the exclusion range. The exclusion range is a range where a lower limit is (Vn−ε) and an upper limit is (Vn+¿). ε is a predetermined constant set so that the exclusion range is near the vehicle speed Vn. In other words, the CPU 11 excludes the corresponding stationary observation point information items when Vt<(Vn−ε) or Vt>(Vn+ε).

The vehicle speed estimation device 4 configured in this manner excludes the stationary observation point information items that includes the relative speeds Vr that satisfy the predetermined speed exclusion conditions indicating that the magnitude of the forward direction component of the vehicle VH at the relative speed Vr (i.e., the forward direction component Vt of the relative speed Vr) is not close to the traveling speed calculated based on the rotational speed of the wheels of the vehicle VH (i.e., the vehicle speed Vn). Note that, the vehicle speed estimation device 4 calculates the forward direction component Vt of the relative speed Vr based on the relative speed Vr and the horizontal azimuth angle θ included in the stationary observation point information items for each of the plurality of stationary observation point information items. The speed exclusion condition in the present embodiment is that the forward direction component Vt of the relative speed Vr is outside the predetermined exclusion range.

Such a vehicle speed estimation device 4 can reduce the contribution of the observation point information items that results in the vehicle speed estimation that deviate from the true value, thereby improving the accuracy of the vehicle speed estimation for the vehicle VH.

In the embodiment described above, S75 corresponds to the process as a selection unit.

### Seventh Embodiment

The seventh embodiment of the present disclosure will be described below with reference to the accompanying drawings. Note that in the seventh embodiment, points that differ from the first embodiment will be explained. The same reference signs are used for common components.

A vehicle speed estimation system 1 of the seventh embodiment differs from the first embodiment in that the vehicle speed estimation process has been changed.

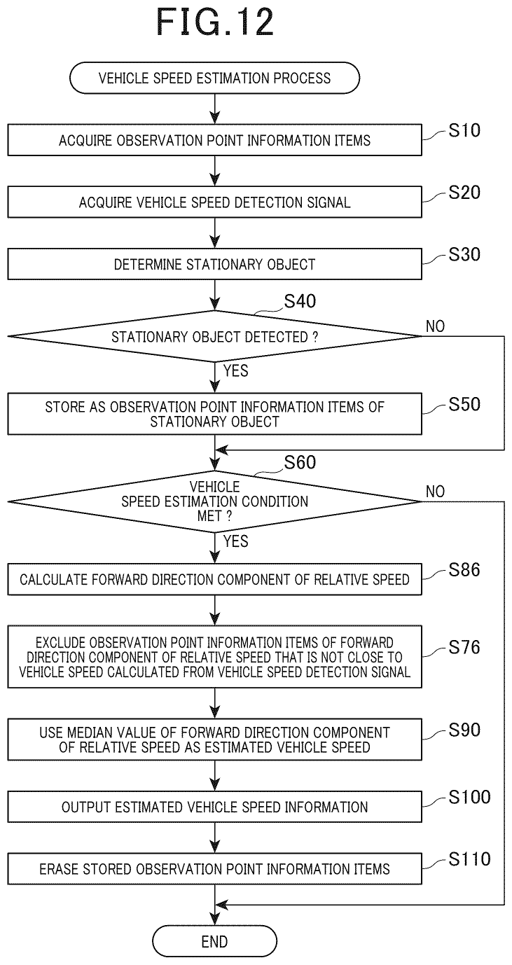

The vehicle speed estimation process of the seventh embodiment differs from the first embodiment in that the process of S76 is executed instead of the process of S70, the process of S86 is executed instead of the process of S80, and the process of S76 is executed after executing the process of S86, as shown in FIG. 12.

That is, when the vehicle speed estimation condition is satisfied in S60, the CPU 11 calculates, in S86, the forward direction component Vt of the relative speed Vr included in the stationary observation point information items for each of the stationary observation point information items stored in the RAM 13.

When the process of S86 is completed, the CPU 11 excludes, at S76, the stationary observation point information items that are not in the vicinity of the vehicle speed Vn calculated from the vehicle speed detection signal, and advances the process to S90. Specifically, the CPU 11, similar to S75, determines whether the forward direction component Vt of the relative speed Vr included in each of the stationary observation point information item stored in the RAM 13 is outside a predetermined exclusion range, and excludes the corresponding stationary observation point information items when the forward direction component Vt is outside the exclusion range.

The vehicle speed estimation device 4 configured in this manner excludes the stationary observation point information items that include the relative speeds Vr that satisfy the predetermined speed exclusion conditions indicating that the magnitude of the forward direction component of the vehicle VH at the relative speed Vr (i.e., the forward direction component Vt of the relative speed Vr) is not close to the traveling speed calculated based on the rotational speed of the wheels of the vehicle VH (i.e., the vehicle speed Vn). Note that, the vehicle speed estimation device 4 calculates the forward direction component Vt of the relative speed Vr based on the relative speed Vr and the horizontal azimuth angle θ included in the stationary observation point information items for each of the plurality of stationary observation point information items. The speed exclusion condition in the present embodiment is that the forward direction component Vt of the relative speed Vr is outside the predetermined exclusion range.

Such a vehicle speed estimation device 4 can reduce the contribution of the observation point information items that results in the vehicle speed estimation that deviate from the true value, thereby improving the accuracy of the vehicle speed estimation for the vehicle VH.

In the embodiment described above, S76 corresponds to the process as a selection unit. The above describes one embodiment of the present disclosure, but the present disclosure is not limited to the above embodiments and may be implemented in various modifications.

### Modification 1

For example, in the above embodiments, although a moving object is shown to be a vehicle VH, a moving object is not limited to this, and may be, for example, a motorcycle.

### Modification 2

In the above embodiments, although the radar device 2 employs an FMCW method, the radar method of the radar device 2 may be any method capable of detecting relative speed, and may, for example, employ a two-frequency CW method or an FCM method. FCM stands for Fast-Chirp Modulation.

### Modification 3

In the above first to seventh embodiments, although the processes S70, S71, S72, S73, S74, S75, and S76 are shown to be performed respectively, the processes S70 to S76 may be combined to exclude the observation point information items. For example, processes S70, S72, and S75 may be combined, processes S71 and S73 may be combined, or processes S74 and S75 may be combined.

### Modification 4

In the above fourth embodiment, although S73 shows a form in which the stationary observation point information items other than the stationary objects with the fastest relative speed within each azimuth range is excluded, S73 may also exclude the stationary observation point information items other than the stationary objects with the shortest distance within each azimuth range.

### Modification 5

In the above embodiments, in S30, it is determined that the observation point is a point reflected by a stationary object when the absolute value of (Vn−Vr/cos θ) is close to 0. However, this is not the only method for determining whether an observation point is a stationary object or a reflected point. For example, by sequentially recording the traveling speed of the vehicle VH, the direction of travel of the vehicle VH, and the position of the observation point observed by the radar device 2, it is possible to calculate the time change in the position of the observation point in a two-dimensional orthogonal coordinate system with the position of the vehicle VH at a certain point in time as the origin. If the position of the observation point in this two-dimensional orthogonal coordinate system does not change over time, it can be determined that this observation point is a point reflected by a stationary object. Note that instead of using the traveling speed and direction of the vehicle VH, the position of the vehicle VH may be calculated based on GPS information. GPS stands for Global Positioning System.

Further, when the observation point detected by the radar device 2 is a location where a stationary object is reflected (i.e., a stationary observation point), as the vehicle VH approaches the stationary observation point and the horizontal azimuth angle θ of the stationary observation point increases, the relative speed Vr of the observation point detected by the radar device 2 decreases. For this reason, it is possible to sequentially record the relative speed Vr and the horizontal azimuth angle θ of the same observation point and plot them in a two-dimensional orthogonal coordinate system with the horizontal azimuth angle θ as the horizontal axis and the relative speed Vr as the vertical axis. If the plotted points are distributed near the stationary object curve that shows the relationship between the horizontal azimuth angle θ and the relative speed Vr when assumed to be a stationary observation point, it can be determined that this observation point is the point where the signal was reflected by a stationary object.

A vehicle speed estimation device 4 and methods described in the present disclosure may be realized by a dedicated computer provided by configuring a processor and memory programmed to perform one or more functions embodied by the computer program. Alternatively, the vehicle speed estimation device 4 and method described in the present disclosure may be implemented by a dedicated computer provided by configuring a processor with one or more dedicated hardware logic circuits. Alternatively, the vehicle speed estimation device 4 and methods described in the present disclosure may be realized by one or more dedicated computers composed of a processor and memory programmed to perform one or more functions, in combination with a processor composed of one or more hardware logic circuits. In addition, the computer program may also be stored in a computer-readable, non-transitory tangible storage media as instructions to be executed by a computer. The method for realizing the functions of each unit included in the vehicle speed estimation device 4 does not necessarily need to include software, and all of the functions may be realized using one or more pieces of hardware.

A plurality of functions possessed by one component in the above embodiment may be realized by a plurality of components, or a single function possessed by one component may be realized by a plurality of components. In addition, a plurality of functions possessed by a plurality of components may be realized by a single component, or a single function realized by a plurality of components may be realized by a single component. In addition, some parts of the configuration of the above embodiments may be omitted. Further, at least a part of the configuration of the above embodiments may be added to or replaced with the configuration of the other embodiments.

In addition to the vehicle speed estimation device 4 described above, it is also possible to implement the disclosure in various forms, such as a system including the vehicle speed estimation device 4 as a constituent element, a program for causing a computer to function as the vehicle speed estimation device 4, a non-transitory tangible storage medium such as a semiconductor memory recording the program, and a vehicle speed estimation method.

### Technical Concept Disclosed in the Present Specification

### [Item 1]

A traveling speed estimation device including:
an information acquisition unit configured to repeatedly acquire, from a radar device mounted on a moving object and transmitting and receiving radar waves, observation point information items including at least an observation point relative speed, which is a relative speed between an observation point that reflects the radar wave and the radar device, and an observation point azimuth angle, which is an azimuth angle at which the observation point exists;
a selection unit configured to select observation point information items from which a traveling speed of the moving object can be estimated that is closest to a true value from among a plurality of observation point information items; and
an estimation unit configured to estimate the true value of the traveling speed based on the observation point relative speed and the observation point azimuth angle of one or more of the observation point information items selected by the selection unit.

### [Item 2]

The traveling speed estimation device according to item 1, wherein
the traveling speed estimation device further includes a stationary object determination unit configured to determine whether the observation point is a stationary observation point that is a point at which the radar wave is reflected by a stationary object that is an object that is at rest; and
the selection unit selects the observation point information items from which a traveling speed of the moving object can be estimated that is closest to a true value from the observation point information items that the stationary object determination unit has determined to be the stationary observation point.

### [Item 3]

The traveling speed estimation device according to item 1 or item 2, wherein
the selection unit selects the observation point information items by excluding the observation point information items that cause errors, which are factors that increase the error between the estimated value and the true value when the estimation unit estimates the true value.

### [Item 4]

The traveling speed estimation device according to item 3, wherein
the selection unit excludes the observation point information items that constitute an angle error factor, which is an error factor caused by the observation point azimuth angle.

### [Item 5]

The traveling speed estimation device according to item 4, wherein
the selection unit excludes the observation point information items that cause the angle error factor by excluding the observation point information items so that the number of the observation point information items at an observation point located on the left side of the moving object matches the number of the observation point information items at an observation point located on the right side of the moving object.

### [Item 6]

The traveling speed estimation device according to item 4, wherein
the observation point azimuth angle includes a horizontal azimuth angle, which is an azimuth angle along the horizontal direction relative to the moving object; and
the selection unit excludes the observation point information items that cause the angle error factor by excluding the observation point information items that satisfy a predetermined horizontal azimuth angle exclusion condition indicating that the horizontal azimuth angle is large.

### [Item 7]

The traveling speed estimation device according to any one of items 1 to 6, wherein
the selection unit excludes the observation point information items of the observation point located above or below the moving object.

### [Item 8]

The traveling speed estimation device according to item 7, wherein
the observation point azimuth angle includes a vertical azimuth angle, which is an azimuth angle along the vertical direction relative to the moving object, and
the selection unit excludes the observation point information items of the observation point located above or below the moving object by excluding the observation point information items that satisfy a predetermined vertical azimuth angle exclusion condition indicating that the vertical azimuth angle is large.

### [Item 9]

The traveling speed estimation device according to item 7, wherein
the observation point azimuth angle includes a horizontal azimuth angle, which is an azimuth angle along the horizontal direction relative to the moving object,
the selection unit classifies each of the observation point information item into one of a plurality of horizontal azimuth angle ranges based on the observation point azimuth angle included in the observation point information items, and
the selection unit excludes, for each of the plurality of horizontal azimuth angle ranges, from one or more observation point information items belonging to the horizontal azimuth angle range, observation point information items other than the observation point information items having the highest observation point relative velocity or the observation point information items having the smallest observation point distance, which is a distance between the observation point and the radar device, thereby excluding the observation point information items of the observation point located above or below the moving object.

### [Item 10]

The traveling speed estimation device according to item 7, wherein
the observation point information items include an observation point distance, which is a distance between the observation point and the radar device, and
the selection unit excludes the observation point information items of the observation point located above or below the moving object by excluding the observation point information items that satisfy a predetermined distance exclusion condition indicating that the observation point distance is short.

### [Item 11]

The traveling speed estimation device according to any one of items 1 to 10, wherein
the selection unit excludes the observation point information items that include the observation point relative speeds that satisfy a predetermined speed exclusion condition indicating that the magnitude of a forward direction component of the moving object in the observation point relative speed is not close to the traveling speed calculated based on a rotational speed of wheels of the moving object.

### [Item 12]

The traveling speed estimation device according to item 11, wherein
the observation point azimuth angle includes a horizontal azimuth angle, which is an azimuth angle along the horizontal direction relative to the moving object, and
the selection unit calculates the forward direction component of the observation point relative speed based on the observation point relative speed and the horizontal azimuth angle included in the observation point information items for each of the observation point information items.

### [Item 13]

The traveling speed estimation device according to any one of items 1 to 12, wherein
the estimation unit estimates the true value of the traveling speed by calculating one or more median values, average values, or most frequent values of the traveling speed calculated based on each of the one or more observation point information items selected by the selection unit.

### [Item 14]

A traveling speed estimation device including:
at least one of (i) a circuit and (ii) a processor with a memory storing computer program code executable by the processor, the at least one of the circuit and the processor configured to cause the traveling speed estimation device to:
repeatedly acquire, from a radar device mounted on a moving object and transmitting and receiving radar waves, observation point information items including at least an observation point relative speed, which is a relative speed between an observation point that reflects the radar wave and the radar device, and an observation point azimuth angle, which is an azimuth angle at which the observation point exists;
select observation point information items from which a traveling speed of the moving object can be estimated that is closest to a true value from among a plurality of observation point information items; and
estimate the true value of the traveling speed based on the observation point relative speed and the observation point azimuth angle of one or more of the observation point information items.

What is claimed is:

1. A traveling speed estimation device comprising:
an information acquisition unit configured to repeatedly acquire, from a radar device mounted on a moving object and transmitting and receiving radar waves, observation point information items including at least an observation point relative speed, which is a relative speed between an observation point that reflects the radar wave and the radar device, and an observation point azimuth angle, which is an azimuth angle at which the observation point exists;
a selection unit configured to select observation point information items from which a traveling speed of the moving object can be estimated that is closest to a true value from among a plurality of observation point information items; and
an estimation unit configured to estimate the true value of the traveling speed based on the observation point relative speed and the observation point azimuth angle of one or more of the observation point information items selected by the selection unit.

2. The traveling speed estimation device according to claim 1, wherein
the traveling speed estimation device further includes a stationary object determination unit configured to determine whether the observation point is a stationary observation point that is a point at which the radar wave is reflected by a stationary object that is an object that is at rest; and
the selection unit selects the observation point information items from which a traveling speed of the moving object can be estimated that is closest to a true value from the observation point information items that the stationary object determination unit has determined to be the stationary observation point.

3. The traveling speed estimation device according to claim 1, wherein
the selection unit selects the observation point information items by excluding the observation point information items that cause errors, which are factors that increase the error between the estimated value and the true value when the estimation unit estimates the true value.

4. The traveling speed estimation device according to claim 3, wherein
the selection unit excludes the observation point information items that constitute an angle error factor, which is an error factor caused by the observation point azimuth angle.

5. The traveling speed estimation device according to claim 4, wherein
the selection unit excludes the observation point information items that cause the angle error factor by excluding the observation point information items so that the number of the observation point information items at an observation point located on the left side of the moving object matches the number of the observation point information items at an observation point located on the right side of the moving object.

6. The traveling speed estimation device according to claim 4, wherein
the observation point azimuth angle includes a horizontal azimuth angle, which is an azimuth angle along the horizontal direction relative to the moving object; and
the selection unit excludes the observation point information items that cause the angle error factor by excluding the observation point information items that satisfy a predetermined horizontal azimuth angle exclusion condition indicating that the horizontal azimuth angle is large.

7. The traveling speed estimation device according to claim 1, wherein
the selection unit excludes the observation point information items of the observation point located above or below the moving object.

8. The traveling speed estimation device according to claim 7, wherein
the observation point azimuth angle includes a vertical azimuth angle, which is an azimuth angle along the vertical direction relative to the moving object, and
the selection unit excludes the observation point information items of the observation point located above or below the moving object by excluding the observation point information items that satisfy a predetermined vertical azimuth angle exclusion condition indicating that the vertical azimuth angle is large.

9. The traveling speed estimation device according to claim 7, wherein
the observation point azimuth angle includes a horizontal azimuth angle, which is an azimuth angle along the horizontal direction relative to the moving object,
the selection unit classifies each of the observation point information item into one of a plurality of horizontal azimuth angle ranges based on the observation point azimuth angle included in the observation point information items, and
the selection unit excludes, for each of the plurality of horizontal azimuth angle ranges, from one or more observation point information items belonging to the horizontal azimuth angle range, observation point information items other than the observation point information items having the highest observation point relative velocity or the observation point information items having the smallest observation point distance, which is a distance between the observation point and the radar device, thereby excluding the observation point information items of the observation point located above or below the moving object.

10. The traveling speed estimation device according to claim 7, wherein
the observation point information items include an observation point distance, which is a distance between the observation point and the radar device, and
the selection unit excludes the observation point information items of the observation point located above or below the moving object by excluding the observation point information items that satisfy a predetermined distance exclusion condition indicating that the observation point distance is short.

11. The traveling speed estimation device according to claim 1, wherein
the selection unit excludes the observation point information items that include the observation point relative speeds that satisfy a predetermined speed exclusion condition indicating that the magnitude of a forward direction component of the moving object in the observation point relative speed is not close to the traveling speed calculated based on a rotational speed of wheels of the moving object.

12. The traveling speed estimation device according to claim 11, wherein
the observation point azimuth angle includes a horizontal azimuth angle, which is an azimuth angle along the horizontal direction relative to the moving object, and
the selection unit calculates the forward direction component of the observation point relative speed based on the observation point relative speed and the horizontal azimuth angle included in the observation point information items for each of the observation point information item.

13. The traveling speed estimation device according to claim 1, wherein
the estimation unit estimates the true value of the traveling speed by calculating one or more median values, average values, or most frequent values of the traveling speed calculated based on each of the one or more observation point information items selected by the selection unit.

14. A traveling speed estimation device comprising:
at least one of (i) a circuit and (ii) a processor with a memory storing computer program code executable by the processor, the at least one of the circuit and the processor configured to cause the traveling speed estimation device to:
repeatedly acquire, from a radar device mounted on a moving object and transmitting and receiving radar waves, observation point information items including at least an observation point relative speed, which is a relative speed between an observation point that reflects the radar wave and the radar device, and an observation point azimuth angle, which is an azimuth angle at which the observation point exists;
select observation point information items from which a traveling speed of the moving object can be estimated that is closest to a true value from among a plurality of observation point information items; and
estimate the true value of the traveling speed based on the observation point relative speed and the observation point azimuth angle of one or more of the observation point information items.
